(19) United States
(12) Patent Application Publication
(10) Pub. No.: US 2012/0136822 A1
(43) Pub. Date: May 31, 2012

(54) KEY PERFORMANCE INDICATOR FEEDBACK IN RULE-BASED SYSTEM

(75) Inventor: Daniel C. Selman, Plevin (FR)

(73) Assignee: INTERNATIONAL BUSINESS MACHINES CORPORATION, Armonk, NY (US)

(21) Appl. No.: 12/969,523

(22) Filed: Dec. 15, 2010

(30) Foreign Application Priority Data
Nov. 25, 2010 (EP) 10306295.6

(51) Int. Cl. G06N 5/02

(52) U.S. Cl. 706/47

(57) ABSTRACT

Fitness of rules in a rule-based system is evaluated in an interactive rule, data, and modeling environment that allows a user to receive immediate feedback on fitness of the overall rule set, as well as the fitness of individual rules, and to see how modifications being made by the user with a rule authoring interface are impacting that fitness. This feedback may be used to improve the set of rules with which the rule-based system operates. Simulations on the rule set run in the background, using a representative input data set to exercise the rule set, and fitness is calculated using a fitness function or predictive model. One or more charts showing resulting indicators are preferably displayed within the rule authoring environment, giving the user immediate feedback on the likely impact of the changes he or she is making.

### BACKGROUND

The present invention relates to computing systems, and deals more particularly with obtaining feedback on key performance indicators in a rule-based system.

Today, systems that operate using rules are available for a variety of applications, and such systems are commonly referred to as “rule-based systems”. A rule-based system may be provided where business rules operate upon data to calculate outcomes, such as calculating a risk for a mortgage applied for by a bank customer or calculating a recommended price to charge customers for a hotel booking. Writing a good set of business rules for the rule-based system can be a difficult undertaking, and without a good set of rules, the outcomes calculated by the rule-based system may not provide the best result.

### BRIEF SUMMARY

The present invention is directed to obtaining feedback on key performance indicators in rule-based systems. In one aspect, rule fitness is evaluated in a rule-based system, which further comprises: responsive to detecting a modification to the rule-based system, executing the rule-based system on an input data set to create at least one decision, each decision having a fitness associated therewith; responsive to executing the rule-based system, executing a fitness computation (preferably, in a background mode) to compute rule fitness for the rule-based system; and responsive to executing the fitness computation, causing display (e.g., in a bar graph) of the computed rule fitness. The detected modification may comprise at least one of: a change to content of the input data set; a change to a definition for the input data set; a change to a rule in the rule-based system; and a change to a function that computes the fitness associated with the at least one created decision.

In one approach, the fitness computation further comprises: summing, for each of a plurality of decisions in the rule-based system, the fitness associated therewith to determine an overall fitness of the rule-based system; and summing, for each rule executed to create the plurality of decisions, the fitness associated with each of the plurality of decisions in which the rule was executed to determine a fitness of the rule. Preferably, the determined overall fitness of the rule-based system and the determined fitness for each of at least one of the rules are then displayed.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 illustrates components which may be used when providing an embodiment of the present invention;

FIG. 2 illustrates a format of a decision definition that may be used by a rule-based system, and FIG. 3 illustrates sample values for a decision that uses this definition;

FIG. 4 provides a flow diagram illustrating a sequence of operations which occurs according to an embodiment of the present invention;

FIGS. 5-8 illustrate editing of a sample input data set definition, sample values of an input data record, a sample fitness function, and sample rules in a sample rule set, respectively;

FIG. 9 illustrates an algorithm that may be used for computing fitness of a rule set and fitness of executed rules in the rule set;

FIG. 10 illustrates sample graphical displays that may be provided to illustrate fitness values, according to an embodiment of the present invention;

FIG. 11 provides a flowchart depicting logic which may be used when implementing an embodiment of the present invention; and

FIG. 12 depicts a data processing system suitable for storing and/or executing program code.

### DETAILED DESCRIPTION

An embodiment of the present invention evaluates fitness of rules in a rule-based system, determining key performance indicator feedback. Fitness evaluations are integrated with rule authoring. The feedback may be used to improve the set of rules with which the rule-based system operates.

One example of a rule-based system for business is the WebSphere® ILOG® Business Rule Management System (“BRMS”) system from International Business Machines Corporation (“IBM”). This BRMS provides test and simulation capabilities. (“WebSphere” and “ILOG” are registered trademarks of IBM in the United States, other countries, or both.)

While known rule-based systems provide a number of advantages, known systems decouple the operation of the rule-based system from rule authoring. This makes it more difficult for a rule author to understand the relative “goodness”, also referred to herein as “fitness”, of a particular business rule. It is also more difficult for the rule author to determine whether changes he or she makes to a rule improves the fitness of the rule.

Consider, by way of example, a travel booking system based on rules. It may be desirable to know how much the profit margin of travel to a particular destination, at a particular time of year, would be impacted if a travel discount was offered, or increased. Historical travel booking data may be used in a rule-based system to simulate purchase transactions under various conditions, and these simulated transactions may then be used to provide feedback on the rules used in the simulations.

An embodiment of the present invention integrates running simulations into the rule authoring process for rules (which are also referred to herein as “business rules”). The rule author can therefore obtain nearly real-time feedback on the relative fitness of an edited rule. More particularly, while a user is editing rules, an embodiment of the present invention runs simulations on the rule set in the background, using a representative input data set to exercise the rule set. Key process indicators, also referred to herein as “KPIs”, are calculated using a fitness function or predictive model. KPI charts depicting these indicators are preferably displayed within the rule authoring environment, giving the user immediate feedback on the likely business impact of the rule changes he or she is making. It should be noted that the simulations discussed herein may also be performed responsive to edits being made to input data records, input data definitions, and/or the fitness function which is applied to an output record, and an embodiment of the present invention therefore more generally provides an interactive rule, data, and modeling environment that allows the user to receive immediate feedback on fitness of the overall rule set and how the modifications being made are impacting that fitness. Accordingly, references herein to rule authoring or rule editing are therefore by way of illustration but not of limitation of the editing that may trigger evaluation of a rule set to generate KPIs.

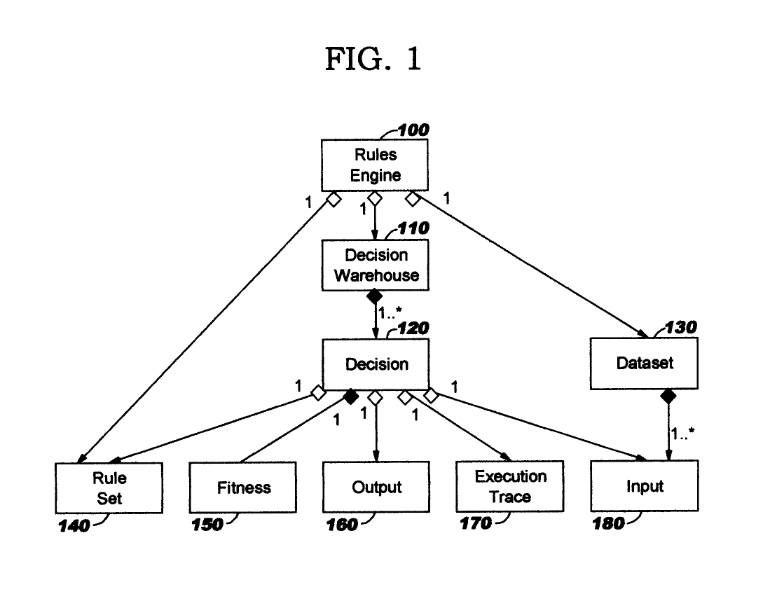

Components in one embodiment of a system that integrates rule authoring with running simulations to provide key feedback indicators, as disclosed herein, will now be described with reference to FIG. 1.

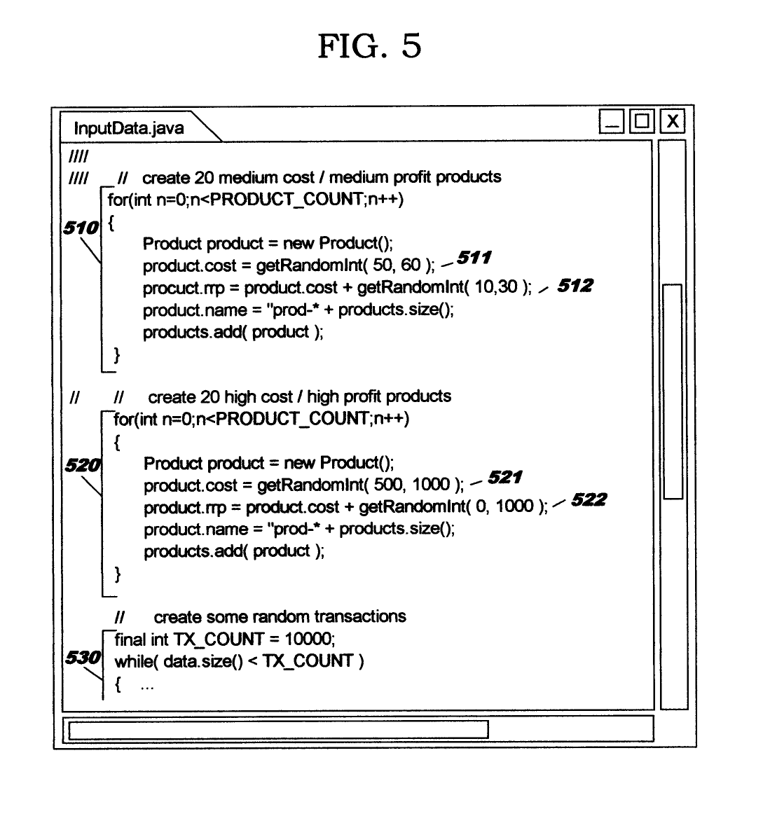

Components shown in FIG. 1 comprise a rules engine 100, a decision warehouse 110, at least one decision 120, an input dataset 130, a rule set 140, a fitness value 150, an output record 160, an execution trace 170, and an input record 180. A rule authoring interface (not shown in FIG. 1) is also provided for use by persons who edit rules and/or data, and is illustrated in FIGS. 5-8. The components shown in FIG. 1 will now be described in more detail.

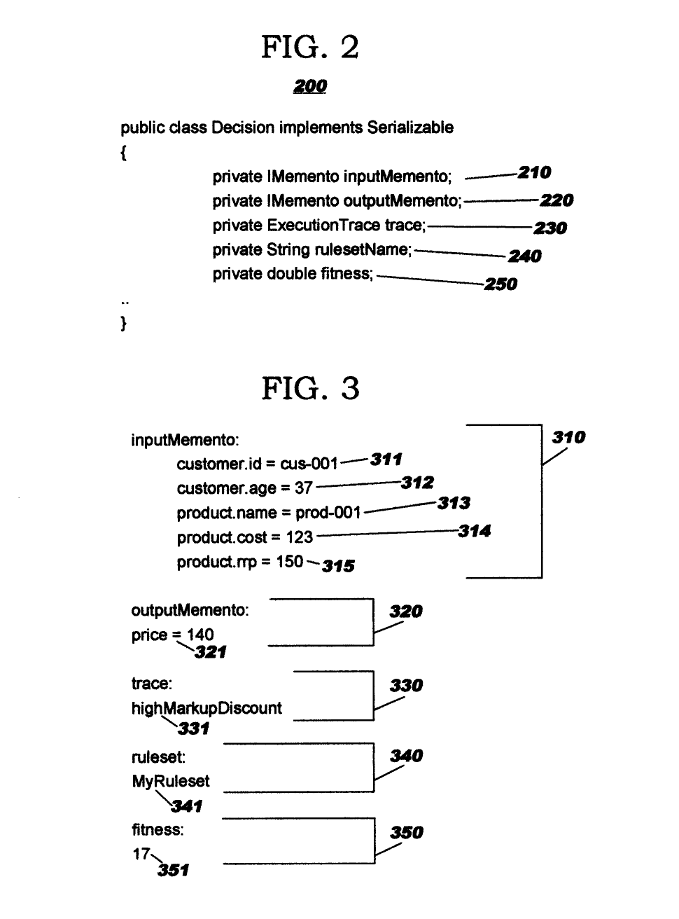

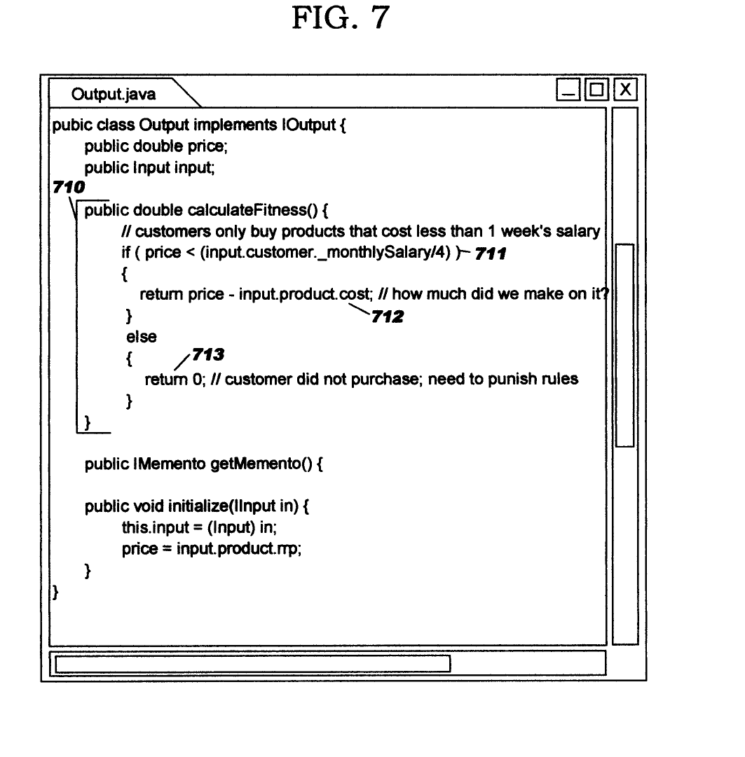

Rules engine 100 is used to compute a decision by firing a rule or rules from rule set 140 during evaluation of an input data record 180 from input dataset 130. A number of decisions may be computed by firing rules, and these decisions are stored in decision warehouse 110. FIG. 2 illustrates a representative format definition 200 for a decision. As illustrated in FIG. 2, each individual decision 120 preferably identifies the input data 210 which was used for this decision; the computed output data 220; an execution trace 230 that lists the names of rules that were executed on the input data for this decision; a rule set identifier 240, which indicates the set of rules that were used to compute this decision; and a computed numeric fitness value 250 for this decision (as discussed in more detail below with regard to fitness function 710 of FIG. 7).

FIG. 3 illustrates sample values 300 for a decision that uses definition 200 of FIG. 2. In the example scenario that is used in FIGS. 3, 5-8, and 10 herein, the rule-based system is evaluating the net profit that may result when products are sold with a price that has one of several discounts applied. Suppose that it is known, by historical sales data, that the amount of the discount impacts the number of purchase transactions for the products. Accordingly, simulations may be performed to predict which customers will buy the products at various discounted prices. As shown by the sample data in FIG. 3, the input data 310 provides a customer identifier 311, a customer age 312, a product identifier 313, a product cost 314, and a recommended retail price 315 for the product. The sample output data 320 is computed by applying the rule set to input data 310. In this example scenario, the output 320 indicates that the retail price should be discounted to $140 (see 321), for the particular customer and product which are simulated by input data 310, rather than charging the recommended retail price of $150 (see 315). Note that the input data 310 corresponds to input data record 180 of FIG. 1, and the output data 320 corresponds to output data 160 of FIG. 1.

The sample decision values 300 further comprise execution trace 330, which indicates that a rule named “highMarkupDiscount” 331 was executed on sample input data 310 to create output data 320, and rule set identifier 340 indicates that the set of rules named “MyRuleset” 341 was used to compute this decision. FIG. 3 further shows that the sample fitness value 350 computed for this decision is 17 (see 351). The fitness value is a relative value, in preferred embodiments, and may therefore be interpreted by contrasting to other fitness values. Note that the set of rules named by rule set identifier 340 corresponds to rule set 140 of FIG. 1, the fitness value 350 corresponds to fitness value 150 of FIG. 1, and the execution trace 330 corresponds to execution trace 170 of FIG. 1.

Referring again to FIG. 1, decision warehouse 110 comprises a persistent store of decisions 120 which have been computed. According to an embodiment of the present invention, decisions stored in decision warehouse 110 are used when computing the fitness of a named rule, and for computing the overall fitness of a rule set. In the general case, fitness values for individual decisions, for rules, and rule sets may be computed as a double-precision numeric value. The fitness value may be a weighted sum, or a multiple of individual KPI calculations. The fitness function which computes fitness for individual decisions may be implemented using a predictive model, whereby historical data is used to predict the statistically-likely outcome of a given decision. For example, based on historical records on loan default, the fitness function may compute the fitness of offering a $100,000 loan to a 35-year-old person with a specific annual income and a specific credit score.

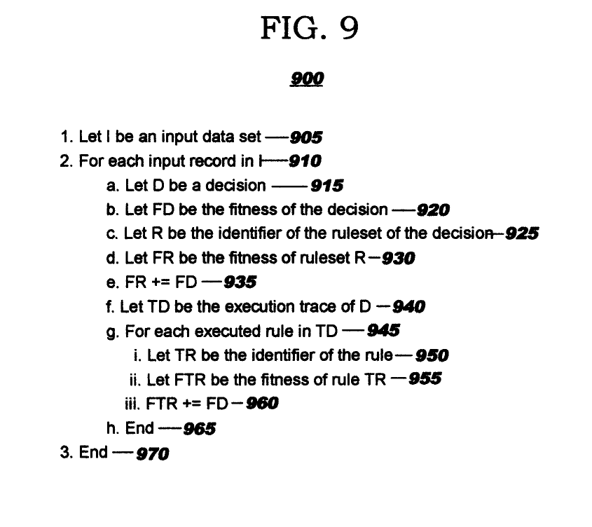

According to one embodiment of the present invention, the fitness of a rule set is computed as the sum of the fitness for all output data 180, as stored in decisions 120, which were calculated using the rule set 140, and the fitness for a given rule is computed as the sum of the fitness for all output data 180 for which this rule was executed. (Refer to FIG. 9, below, for a more detailed discussion of an algorithm for computing fitness for a rule set and for individual rules.)

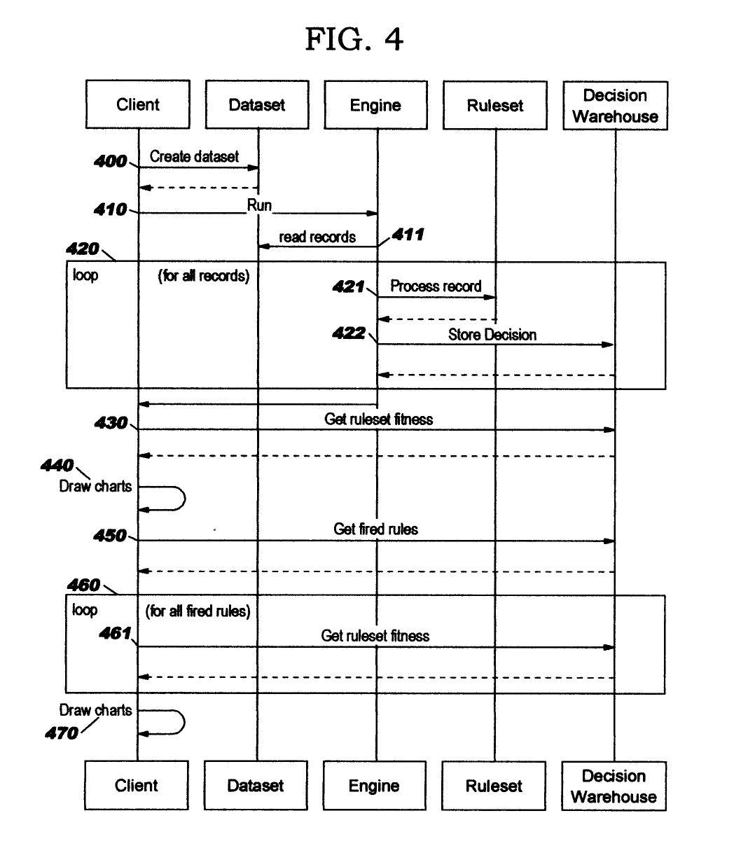

FIG. 4 provides a flow diagram illustrating a sequence of operations which occurs according to an embodiment of the present invention. As shown therein, a client—for example, an end user who is using a rule authoring system—creates 400 an input dataset. This dataset may comprise historical transaction data, data which has been generated for simulations, or a mix thereof. The client runs 410 the rule engine, which reads 411 records from the input dataset. An iterative process 420 is typically performed, whereby all of the records from the input dataset are evaluated by processing 421 each record, in turn, using the rule set. Decisions created from this processing are stored 422 in the decision warehouse.

Using the computed decisions from the decision warehouse, the rule set fitness is computed 430. One or more charts may be presented 440—for example, on a graphical user interface—to represent the computed rule set fitness. The execution trace, which lists the rules which were fired when computing each decision, is obtained 450 from the decision records in the decision warehouse. An iterative process 460 is then performed, according to an embodiment of the present invention, whereby the fitness of each fired rule in the rule set is used in computing 461 the fitness of each rule. One or more charts may be presented 470—for example, on a graphical user interface—to represent the computed fitness of the individual rules.

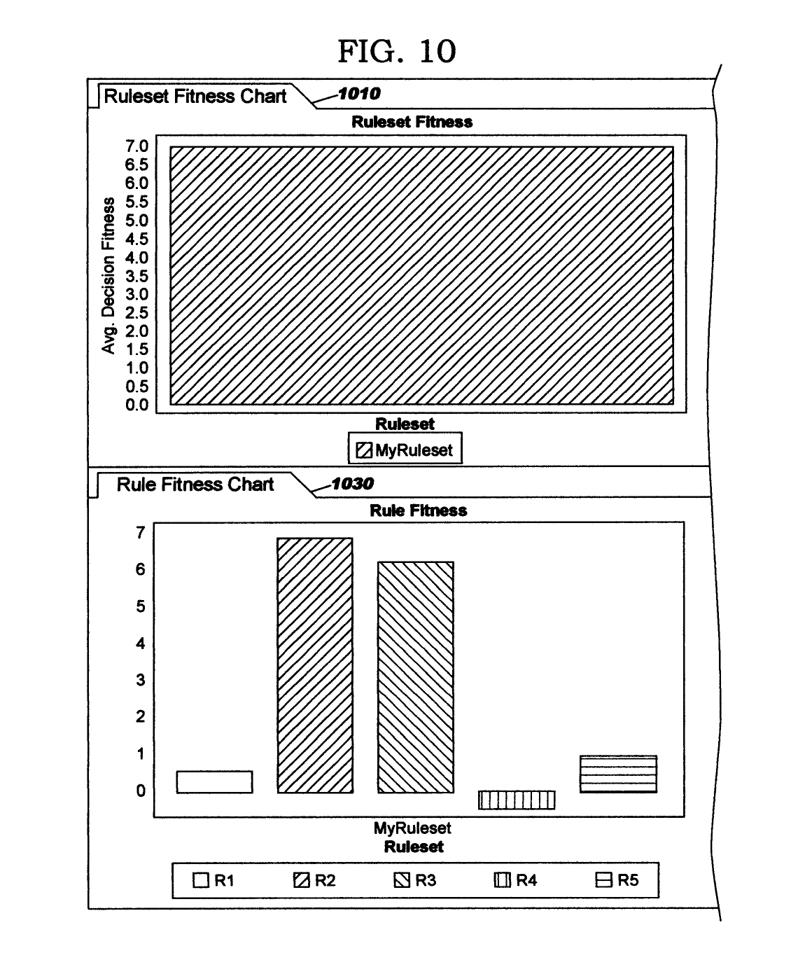

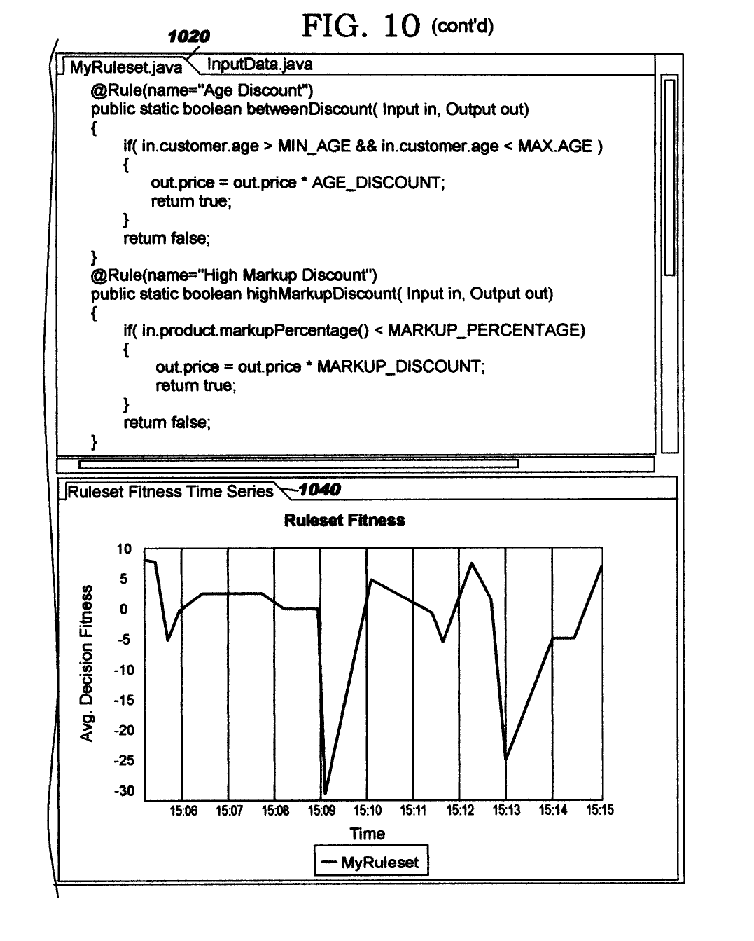

A rule authoring interface may allow a user to edit various data and rules used by the rule-based system. A sample rule authoring interface is illustrated in FIGS. 5-8, where the depicted scenarios comprise editing of a sample input data set definition, editing sample values of an input data record, editing a sample fitness function, and editing sample rules in a sample rule set, respectively. Editing data as illustrated in one or more of these scenarios triggers the background evaluation of key feedback indicators, according to an embodiment of the present invention. FIG. 9 depicts an algorithm that may be used in this background evaluation, and FIG. 10 illustrates sample graphical displays that may be provided to illustrate fitness values computed during this background evaluation. Each of these figures will now be discussed in more detail.

FIG. 5 illustrates editing the definition of an input data set. By editing the data in the data set, the user can evaluate the fitness of a rule set when used with different input scenarios. The data set might comprise historical transactions representing purchasing habits of customers who live in a particular zip code or other postal code, for example. Editing the input data set might then comprise providing historical transactions for customers in a different zip code to see how the rules are applied to this changed input. Or, the editing might comprise adjusting attributes associated with the existing input records, such as modifying economic information for one or more customers to see how the rules are applied to this changed input.

Rather than using historical transactions as input, in another approach, executable code is used to generate sample input data. This is illustrated by the sample code 500 which is depicted in FIG. 5. As shown therein, a first iterative process 510 generates a set of records representing medium-cost products with medium profit. In particular, the cost of a sample product is a randomly-selected value between 50 and 60 (see 511) and the recommended retail price for this sample product is computed by adding a randomly-selected value between 10 and 30 to the product cost (see 512). A second iterative process 520 generates a set of records representing high-cost products with high profit. In particular, the cost of a sample product is a randomly-selected value between 500 and 1000 (see 521) and the recommended retail price for this sample product is computed by adding a randomly-selected value between 0 and 1000 to the product cost (see 522). The sample product records which are created by the code at 510 and 520 are stored, in one embodiment, in fields 313-315 of input data 310 of FIG. 3. Additional code 530, which is merely representative and is therefore not shown in its entirety, may be used to generate sample transactions. This code 530 may comprise, by way of example, setting sample values for customer identifier 311 and customer age 312 fields of input data 310. The input data created according to FIG. 5 may then be used in simulations.

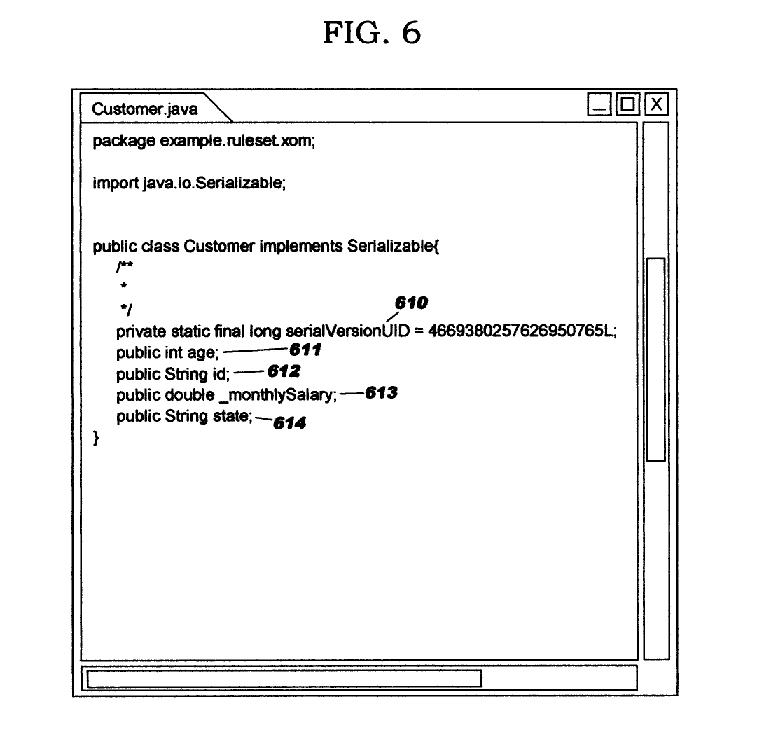

FIG. 6 illustrates editing the definition of a customer data record, which in this example defines part of an input data record. The user can define the structure of the input data model as required to meet the needs of the particular problem domain which is being simulated, and thus it should be understood that FIG. 6 is merely illustrative of a data model. In the example shown in FIG. 6, customer data records are defined to include a unique record identifier 610, an age 611, a customer identifier string 612, monthly salary 613, and state of residence 614. Note that age 611 and customer identifier 612 correspond to the customer age 312 and customer identifier 311 fields of input data 310.

Notably, the fitness function used by an embodiment of the present invention will typically reference data in the input for a decision as well as data in the output computed with the rule set, in order to assign the fitness values for the rule set and rules. The fitness value may therefore be considered a type of “score” for decisions made with the rule set. Suppose, by way of illustration, that an embodiment of the present invention is used with a loan processing problem domain. The input data may comprise loan application data, where a loan application instance includes a variety of fields that may be used to evaluate whether a lender should underwrite the loan, and on what terms. Suppose that an existing predictive model shows that loans for residents of a particular state, who are over a particular age, have a certain percentage chance of going into default. The lender may wish to limit such loans to a fixed percentage of the lender's business in order to control the lender's financial risk. The rule set can then be used in simulations to see how the rules of the rule set make decisions about granting loans to this population of applicants. If the rule set creates decisions that grant loans to too many of these applicants, then the fitness function preferably “punishes” the rules by assigning a relatively low fitness value thereto. This enables the rule author to quickly see that the rules should be modified to grant fewer of these loans, and the modifying may be an iterative process whereby changes are made until the fitness value reaches a desired goal or threshold.

FIG. 7 illustrates editing the fitness function (see 710) used for computing fitness values of the output represented by a decision, which is shown at 150 of FIG. 1. The user can interactively modify the fitness function 710, if desired, to see the effect on the fitness values. Or, the fitness function may be used without change during a simulation, and the computed fitness values may then change due to changes to other components (such as rule changes and/or changes to the input data). In the example scenario, the rule-based system calculates the suggested price of products, where the price reflects a discount. The rule-based system may contain rules for computing different types of discounts, based on different criteria. Suppose, by way of illustration, that a retailer has determined through historical data that customers are not likely to buy products that cost more than one week's salary. Fitness function 710 therefore uses this information to evaluate the impact of price discounts on net profit. In particular, the retailer may want to increase the volume of sales transactions by discounting expensive, high-margin products so that the price of these products is less than one week's salary for the target customers. Because customers have different weekly salaries, one discounted price may appeal to some customers, while an even larger discount may increase the number of potential customers. The retailer may therefore use a rule-based system to predict what discount should be offered. However, in order to ensure that the products are not sold at a loss, the cost of the products must also be considered. Accordingly, fitness function 710 evaluates output from decisions created by the rule set, determining the fitness of the suggested discounted price contained therein (as discussed above with regard to recommended retail price 315 and suggested discounted price 321 of FIG. 3).

More particularly, fitness function 710 determines whether the suggested discounted price from a decision record is less than the weekly salary of a sample customer (see 711), and if so, it is presumed that this customer would buy the product. Accordingly, the difference between the discounted price and the product cost is therefore computed and returned to the invoking code (see 712) as the fitness value for this decision. By contrast, if the discounted price is not less than one week's salary for this customer, it is presumed that this customer would not purchase the product, and a value of zero is therefore returned (see 713) as the fitness value for this decision. If the profit as represented by a cumulative sum of the fitness values from a simulation is relatively low, this may indicate that many of the decisions contained discounted prices which were too high (i.e., the code at 713 was executed, indicating that the purchase was not made), and the fitness function will then cause the rules to be punished by assigning low fitness values thereto. In addition, if the discounted price is less than the cost of the product, then a negative value will be returned at 712, which further punishes rules that set the discounted price lower than the product's cost and would therefore allow products to be sold at a net loss. As can be seen by this example fitness function 710, the fitness can be expected to change when the rules change (because the rules compute the product price); when the input data changes (because the input data defines the transactions being processed by the rules); and when the fitness function itself changes.

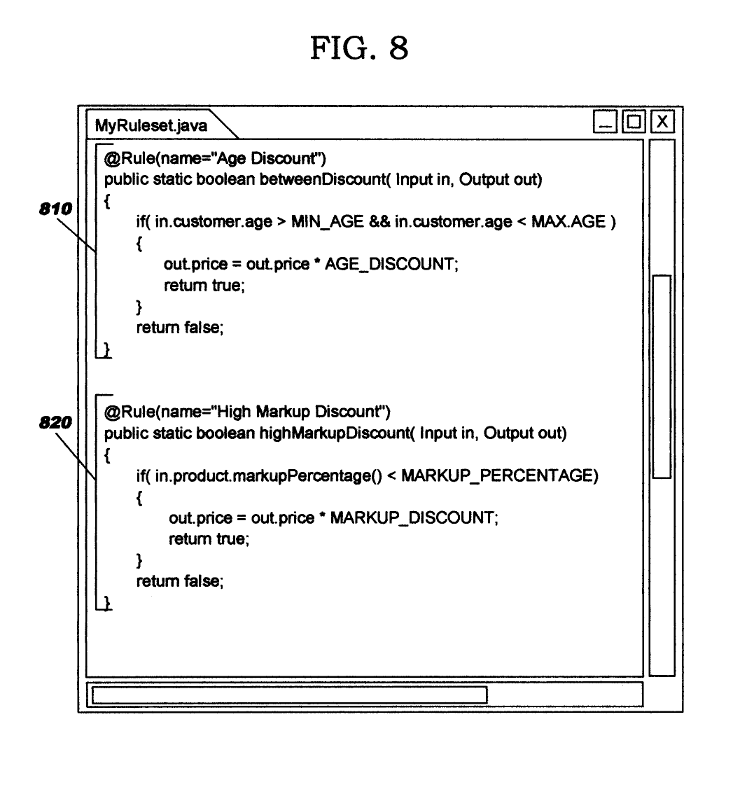

FIG. 8 illustrates editing sample rules in a sample rule set. The editing may comprise modifying one or more existing rules, adding one or more new rules, and/or deleting one or more existing rules. In the sample rule 810, an age discount is applied to a product price for customers in a selected age range, and in sample rule 820, if the markup percentage for a particular product is greater than a threshold value, a different discount is applied to the product price. It will be obvious that various types of edits may be applied to these rules. Using an embodiment of the present invention, the user will receive immediate feedback showing how such changes affect decisions in the problem domain. See, for example, the sample charts in FIG. 10, which are discussed below.

FIG. 9 illustrates an algorithm 900 that may be used for computing fitness of a rule set and fitness of executed rules in the rule set. As noted earlier, this algorithmic evaluation is preferably carried out in a background mode, responsive to detecting that the user has changed one or more of the input data definition, the input data values, the fitness function, and the rules in a rule set. Accordingly, the algorithm 900 shown in FIG. 9 indicates that a variable “I” represents a particular input data set which has been used in creating decisions (see 905). The algorithm iterates over each of the input records in this input data set (see 910). In the illustrated approach, the iterative processing is shown at 915-970, as will now be described.

A variable “D” represents a particular decision for the current input record (see 915), and a variable “FD” represents the fitness of this decision (see 920), as computed using the fitness function. A variable “R” represents the identifier of the rule set used for this decision (see 925), and a variable “FR” represents the fitness value for this rule set (see 930). With reference to FIGS. 1 and 3, it can be seen that “FD” and “R” may be retrieved from the decision record. See reference numbers 150 and 140 of FIG. 1, and reference numbers 351 and 341 of FIG. 3. At 935 of FIG. 9, the fitness “FD” of the currently-processed decision “D” is added to the cumulative fitness “FR” for the rule set “R”. In this manner, the fitness of each decision computed using the rule set is reflected in the rule set fitness “FR”.

Next, a variable “TD” is set to represent the execution trace for the currently-processed decision “D” (see 940). With reference to FIGS. 1 and 3, it can be seen that “TD”—which comprises a list of the rules that were applied to create this decision—may be retrieved from the decision record. See reference number 170 of FIG. 1 and reference number 331 of FIG. 3. The algorithm then iterates over each of these applied rules (see 945), where this iterative processing is shown at 945-965, as will now be described.

A variable “TR” represents the identifier of the currently-processed rule (see 950), and a variable “FTR” represents the fitness of this rule (see 955). At 960, the fitness “FD” of the currently-processed decision “D” is added to the cumulative fitness “FTR” for the currently-process rule “TR”. In this manner, the fitness “FTR” of each particular rule reflects the fitness of the decisions that were computed by applying that rule.

When all of the executed rules have been processed by the iteration at 945-965, and all of the input records have been processed by the iteration at 910-970, the processing of FIG. 9 then ends.

One or more fitness charts or graphs are preferably created using the values computed according to FIG. 9, for display to the user who is using the rule authoring interface. As noted earlier, this provides an interactive rule, data, and modeling environment that allows the user to receive immediate feedback on fitness of the overall rule set, as well as the fitness of individual rules, and to see how the modifications being made are impacting that fitness. Several fitness charts are illustrated in FIG. 10, by way of example. A plurality of charts may be displayed concurrently, as shown in FIG. 10. For example, a chart representing the fitness of the rule set as a whole is shown at 1010, and sample rules from the rule set are illustrated at 1020. Fitness of rules from the rule set is shown in the chart at 1030, and a time-specific fitness for the rule set is shown at 1040 (where chart 1040 illustrates that the fitness of the rule set changes over time, which may be caused by the user continuing to modify the rules and/or values on which the rules operate). Note that the fitness of a particular rule may be compared to fitness of other rules in the rule set, and accordingly, chart 1030 is a bar graph with 5 bars to depict fitness of 5 different rules. For example, with reference to the sample rules 810, 820 of FIG. 8 (which are also shown at 1020 in FIG. 10), one of the bars in chart 1030 preferably corresponds to the “Age Discount” rule 810 and another of the bars in chart 1030 preferably corresponds to the “High Markup Discount” rule 820. This comparison at 1030 may be useful to help the user visualize the relative fitness of a rule being edited, as compared to other rules in the current rule set.

Although FIG. 10 presents key feedback indicators using bar charts, other types of graphical representations may be used without deviating from the scope of the present invention. As one example, pie graphs may be used instead of, or in addition to, bar graphs. Furthermore, visual depictions other than charts and graphs may be used without deviating from the scope of the present invention.

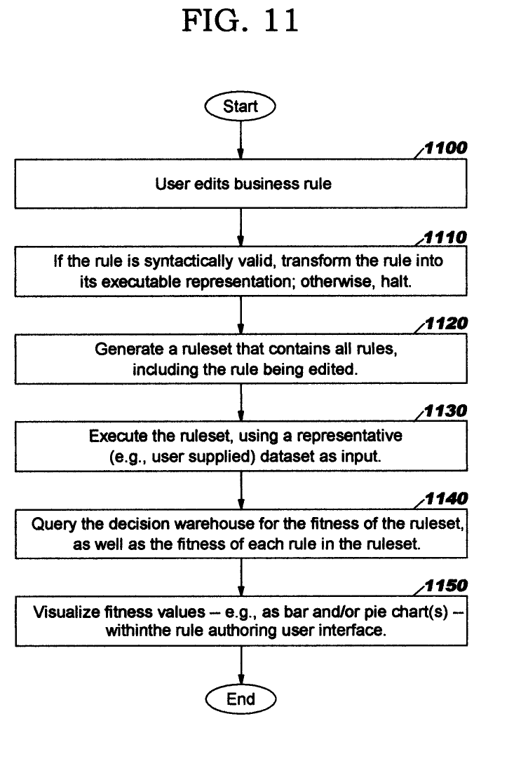

FIG. 11 provides a flowchart depicting logic which may be used when implementing an embodiment of the present invention, and summarizes the above-described processing. As shown therein, a user edits a business rule (Block 1100). If the rule is syntactically valid, it is transformed into an executable representation; otherwise, processing of the rule halts until the user makes appropriate corrections (Block 1110). A rule set is generated or augmented to contain all of the rules for the rule set, including the rule currently being edited (Block 1120). The rule set is then executed (Block 1130) to generate decisions, using a representative data set (which is preferably supplied by the user) as input. The data set may comprise historical records, records which have been generated for simulations, or a mix thereof, as noted earlier. The decisions in the decision warehouse are then queried (Block 1140) to determine the fitness of the rule set, as well as the fitness of each rule in the rule set. The fitness values are presented to the user (Block 1150) within the rule authoring user interface, which may comprise displaying various bar charts and/or pie charts.

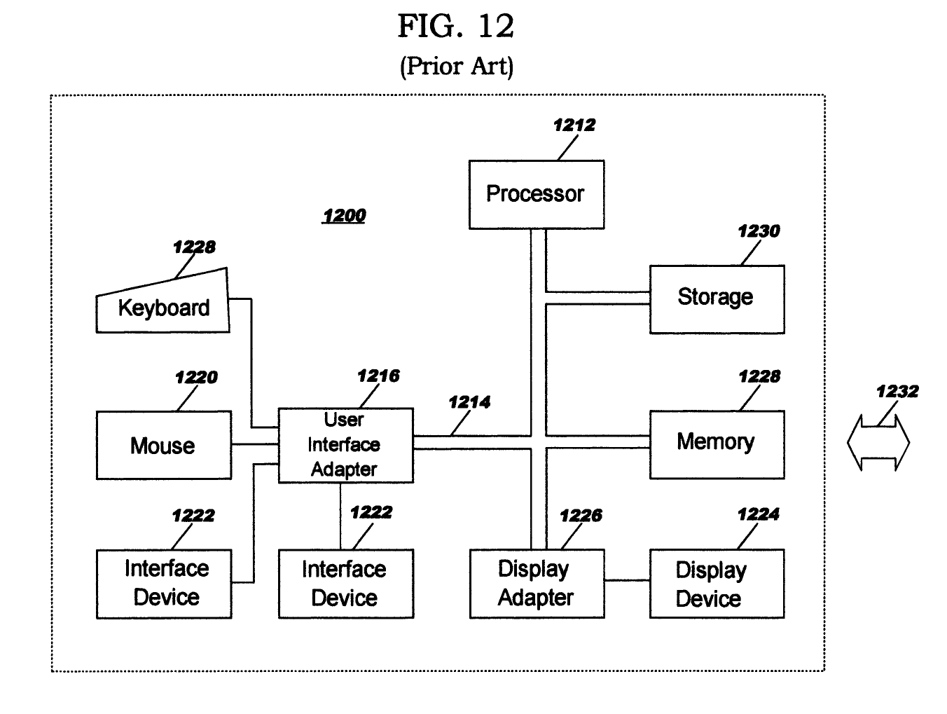

Referring now to FIG. 12, a data processing system 1200 suitable for storing and/or executing program code includes at least one processor 1212 coupled directly or indirectly to memory elements through a system bus 1214. The memory elements can include local memory 1228 employed during actual execution of the program code, bulk storage 1230, and cache memories (not shown) which provide temporary storage of at least some program code in order to reduce the number of times code must be retrieved from bulk storage during execution.

Input/output (“I/O”) devices (including but not limited to keyboards 1218, displays 1224, pointing devices 1220, other interface devices 1222, etc.) can be coupled to the system either directly or through intervening I/O controllers or adapters (1216, 1226).

Network adapters may also be coupled to the system to enable the data processing system to become coupled to other data processing systems or remote printers or storage devices through intervening private or public networks (as shown generally at 1232). Modems, cable modem attachments, wireless adapters, and Ethernet cards are just a few of the currently-available types of network adapters.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of evaluating rule fitness in a rule-based system, comprising:
responsive to detecting a modification to the rule-based system, programmatically executing the rule-based system on an input data set to create at least one decision, each decision having a fitness associated therewith;
responsive to the programmatically executing the rule-based system, programmatically executing a fitness computation to compute rule fitness for the rule-based system; and
responsive to the programmatically executing the fitness computation, causing display of the computed rule fitness.

2. The method according to claim 1, wherein the detected modification comprises at least one of: a change to content of the input data set; a change to a definition for the input data set; a change to a rule in the rule-based system; and a change to a function that computes the fitness associated with the at least one created decision.

3. The method according to claim 1, wherein the computed rule fitness for the rule-based system further comprises an overall fitness of the rule-based system and a fitness for each rule executed on the input data set.

4. The method according to claim 1, wherein the causing display further comprises causing display of at least one of: at least one bar graph and at least one pie graph.

5. The method according to claim 3, wherein the causing display further comprises causing display of a visual depiction of the overall fitness of the rule-based system and a visual depiction of the fitness for at least one rule executed on the input data set.

6. The method according to claim 1, wherein the programmatically executing a fitness computation to compute rule fitness for the rule-based system operates in a background mode from the programmatically executing the rule-based system on an input data set to create at least one decision.

7. The method according to claim 1, wherein a data record storing the decision comprises content of input data, from the input data set, on which the rule-based system executed to create the decision; an output created by the rule-based system executing on the input data; a list comprising a rule identifier for each of at least one rule executed by the rule-based system to create the decision; and the fitness associated with the decision.

8. The method according to claim 7, wherein the data record storing the decision further comprises an identifier of a rule set comprising rules of the rule-based system.

9. The method according to claim 1, wherein:
the fitness computation further comprises:
summing, for each of a plurality of decisions in the rule-based system, the fitness associated therewith to determine an overall fitness of the rule-based system; and
summing, for each rule executed to create the plurality of decisions, the fitness associated with each of the plurality of decisions in which the rule was executed to determine a fitness of the rule; and
the causing display causes display of the determined overall fitness of the rule-based system and the determined fitness for each of at least one of the rules.

10. A system for evaluating rule fitness in a rule-based system, comprising:
a computer comprising a processor; and
instructions which are executable, using the processor, to implement functions comprising:
responsive to detecting a modification to the rule-based system, executing the rule-based system on an input data set to create at least one decision, each decision having a fitness associated therewith;
responsive to the executing the rule-based system, executing a fitness computation to compute rule fitness for the rule-based system; and
responsive to the executing the fitness computation, causing display of the computed rule fitness.

11. The system according to claim 10, wherein the detected modification comprises at least one of: a change to content of the input data set; a change to a definition for the input data set; a change to a rule in the rule-based system; and a change to a function that computes the fitness associated with the at least one created decision.

12. The system according to claim 10, wherein the computed rule fitness for the rule-based system further comprises an overall fitness of the rule-based system and a fitness for each rule executed on the input data set.

13. The system according to claim 10, wherein the executing a fitness computation to compute rule fitness for the rule-based system operates in a background mode from the executing the rule-based system on an input data set to create at least one decision.

14. The system according to claim 10, wherein a data record storing the decision comprises content of input data, from the input data set, on which the rule-based system executed to create the decision; an output created by the rule-based system executing on the input data; a list comprising a rule identifier for each of at least one rule executed by the rule-based system to create the decision; and the fitness associated with the decision.

15. The system according to claim 10, wherein:
the fitness computation further comprises:
summing, for each of a plurality of decisions in the rule-based system, the fitness associated therewith to determine an overall fitness of the rule-based system; and
summing, for each rule executed to create the plurality of decisions, the fitness associated with each of the plurality of decisions in which the rule was executed to determine a fitness of the rule; and
the causing display causes display of the determined overall fitness of the rule-based system and the determined fitness for each of at least one of the rules.

16. A computer program product for evaluating rule fitness in a rule-based system, the computer program product comprising:
a computer readable storage medium having computer readable program code embodied therein, the computer readable program code configured for:
responsive to detecting a modification to the rule-based system, executing the rule-based system on an input data set to create at least one decision, each decision having a fitness associated therewith;
responsive to the executing the rule-based system, executing a fitness computation to compute rule fitness for the rule-based system; and
responsive to the executing the fitness computation, causing display of the computed rule fitness.

17. The system according to claim 16, wherein the detected modification comprises at least one of: a change to content of the input data set; a change to a definition for the input data set; a change to a rule in the rule-based system; and a change to a function that computes the fitness associated with the at least one created decision.

18. The computer program product according to claim 16, wherein the executing a fitness computation to compute rule fitness for the rule-based system operates in a background mode from the executing the rule-based system on an input data set to create at least one decision.

19. The computer program product according to claim 16, wherein a data record storing the decision comprises content of input data, from the input data set, on which the rule-based system executed to create the decision; an output created by the rule-based system executing on the input data; a list comprising a rule identifier for each of at least one rule executed by the rule-based system to create the decision; and the fitness associated with the decision.

20. The computer program product according to claim 16, wherein:
the fitness computation further comprises:
summing, for each of a plurality of decisions in the rule-based system, the fitness associated therewith to determine an overall fitness of the rule-based system; and
summing, for each rule executed to create the plurality of decisions, the fitness associated with each of the plurality of decisions in which the rule was executed to determine a fitness of the rule; and
the causing display causes display of the determined overall fitness of the rule-based system and the determined fitness for each of at least one of the rules.
